(19) United States
(12) Patent Application Publication
(10) Pub. No.: US 2008/0010917 A1
(43) Pub. Date: Jan. 17, 2008

(54) Flexible Wicking Membrane

(76) Inventors: John R. Hopkins, Bow Mar, CO (US); James Scott Ford, Littleton, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/426,246

(22) Filed: Jun. 23, 2006

(51) Int. Cl. E06B 3/26

(52) U.S. Cl. 52/202

(57) ABSTRACT

Disclosed herein are various waterproof membranes that may be applied to a sill surface of an opening in a building structure to waterproof that surface as well as direct water that penetrates through the opening out of the structure. Generally, one or more flexible waterproof membranes are adhesively applied to the sill surface for purposes of waterproofing that surface. Such membranes may further incorporate a back dam structure that is disposed proximate to the rearward edge of a sill plate (i.e., disposed toward the interior of the structure) to direct water towards the front edge of the sill plate (i.e., toward the outside of the structure). Further, such membranes may include wicking material on one or more surfaces to allow for directing water out of a building structure. In various arrangements, one or more flexible membranes may be utilized to create an open fronted sill pan.

### FIELD OF INVENTION

The present invention generally relates to building products and, more particularly, pertains to an impermeable membrane that is adapted to waterproof a surface and wick moisture away from that surface.

### BACKGROUND OF THE INVENTION

One of the most common failure points for unwanted air and/or moisture in a building envelope is around doors and windows. Controlling air and/or moisture is a serious concern, which may result in exterior and interior damage if not prevented or corrected in a timely manner. In addition, heat losses caused by air leakage around building openings have taken on new significance due to today's high energy costs. Sealing such openings has typically been accomplished by caulking or using putty-like compound around openings between door and window frames to seal the gaps and prevent inward seepage of air and/or water into the building.

In window installations, caulking around the window has been the known installation and application method. However, over several years, such caulking typically cracks, as it cannot withstand the constant expansion and contraction of the window. Some studies indicate that after several years in operation, a majority of all windows will leak through the window flange or the window itself. This water leakage can lead to structural damage such as rotting of the windowsills and mold.

Given these problems, there remains a need for an improved method for waterproofing internal components of an opening of a structure and for removing moisture that penetrates into the opening.

### SUMMARY OF THE INVENTION

In view of the difficulties in waterproofing openings into building structures, such as door and window openings, provided herein are systems and methods (i.e., utilities) for use in waterproofing sill surfaces of such openings and/or removing water that penetrates into such an opening. Generally, the utilities discussed herein utilize one or more flexible membranes that are applied to the sill surface for purposes of waterproofing that surface. Such membranes may further incorporate a dam/back dam disposed proximate to the rearward edge of a sill plate (i.e., disposed toward the interior of the structure) to direct water towards the front edge of the sill plate (i.e., toward the outside of the structure). Further, such membranes may include wicking material on one or more surfaces to allow for directing water out of a building structure.

In a first arrangement, a membrane is provided that is operative to direct water away from a surface on which the membrane is applied. Such a membrane may further be utilized to create a sill pan for an opening within a structure. The membrane includes a flexible waterproof sheet having a top surface and a bottom surface wherein a wicking material is attached to a first portion of the top surface. An adhesive surface is associated with a second portion of the top surface. This adhesive surface is covered by a release sheet. The release sheet is releasably attached to the adhesive such that the release sheet may be removed to expose the adhesive surface, which may be contacted with a desired structure.

In one arrangement, the flexible waterproof sheet member and the adhesive surface thereon may be integrally formed. For instance, the sheet member may be formed of a bitumen containing material or rubberized material. In such an arrangement, the bitumen or rubberized material, or other material providing waterproofing and adhesive qualities, may be formed into a sheet-like member. Accordingly, this may permit attaching the wicking material directly to the surface of the sheet member without additional adhesives. In another arrangement, the sheet material may not include adhesive qualities. In such an arrangement, an adhesive may be applied to the top surface of the sheet member to attach the wicking material and/or to provide an adhesive surface for contacting with additional structures.

In another arrangement, at least a portion of the bottom surface of the sheet member is an adhesive surface. Again, an adhesive may be applied to the bottom surface or may be integrally formed with the sheet member. Likewise, a release sheet may be releasably attached to the bottom adhesive surface. In a further arrangement, a first portion of the bottom surface comprises an adhesive surface, and a second portion of the bottom surface is formed as a non-adhesive surface. In one particular arrangement, a portion of the surface that forms a non-adhesive surface corresponds at least in part to the adhesive top surface of the membrane.

According to another arrangement, a utility is provided for forming a sill pan on a sill surface in an opening of a building structure. The utility includes disposing a flexible membrane across the length of a generally horizontal sill surface. Such a sill surface is typically disposed between first and second upright members (e.g., studs). In addition to being disposed across the length of the sill surface, the flexible membrane may, but not necessarily, include a first end that extends at least partially up a first upright member and a second end that extends at least partially up the second upright member. A rearward edge of the membrane (e.g., disposed towards the inside of the structure) that is disposed between the first and second uprights may be folded transverse to the generally horizontal sill surface. This resulting transverse portion of the membrane forms a barrier or back dam between the first and second uprights. This back dam prevents water on the sill from infiltrating into the building structure.

In cases where end portions of the membrane extend partially up the uprights, the interface between the back dam and the portions of the membrane that extend partially up the upright members may form a watertight corner. For instance, a dog-ear field may be made at an angle between the upright member and the transverse back dam. The resulting ear may be folded against one of the uprights and the back dam. Alternatively, a sealant may be applied to the interface.

Of note, as the back dam is formed from the flexible membrane, it may require support along its length to maintain its transverse position relative to the horizontal sill surface. Accordingly, the back dam may be secured to a window or door that is disposed over the membrane across the sill surface. In one arrangement, such securement may entail removing a release sheet from at least a portion of the back dam to thereby expose an adhesive surface. This adhesive surface may then be contacted to the door or window placed on the sill surface.

Forming the sill pan may further entail removing a release sheet from at least a portion of the bottom surface of the flexible membrane to expose a bottom adhesive surface. This bottom adhesive surface may be contacted to at least a portion of the sill surface. Further, end portions of the bottom surface may be contacted to the first and second upright members. In such an arrangement, the flexible membrane may be adhered to the sill surface and upright members.

In further arrangement, a top surface of the membrane may include a wicking material that is adapted for directing water away from the back dam and out of the building structure. In such an arrangement, the wicking material may extend over a top surface of the membrane from, for example, the back dam to a front edge of the membrane, which may extend over a front edge of the opening. Accordingly, the membrane may be adhered to a surface transverse to the sill surface. For instance, the front edge of the membrane may be adhered to an outside surface of the building structure. The wicking material may then be operative to wick material from within the building structure to a location outside of the building structure.

According to another arrangement, a utility is provide wherein a back dam material is connected to the waterproof membrane. In such an arrangement, a spacer material may be disposed on the bottom surface of the membrane to provide a back dam along the rearward edge (e.g., inside edge) of a sill surface. In such an arrangement, the flexible membrane may be disposed across the length of a generally horizontal sill surface disposed between first and second upright members. The flexible membrane may be of a length that allows a first end portion of the membrane to extend at least partially up the first upright member and a second end portion of the flexible membrane to extend at least partially up the second upright member. To allow for better conformance of the first and second end portions of the membrane to the upright members, the spacer material disposed on the bottom surface of the flexible membrane may be removed from the bottom surface of the first and second end portions. At this time, a release sheet may be removed from at least a portion of the bottom surface of the flexible membrane to expose a bottom adhesive surface, and that bottom adhesive surface may be contacted to the sill surface and/or upright members.

In one arrangement, the spacer material may be disposed across the length of the sill surface between the first and second upright members in order to provide higher elevation at the rearward edge of the sill and thereby provide a positive slope to drain water to the front of the sill and out of the building structure. Accordingly, wicking material may be connected to the top surface of the membrane to improve water flow.

The spacer material may be any material that maintains a rearward portion of the membrane elevated. Such material may include flexible materials, (e.g., foams, plastic etc)closed or open cell) as well as rigid materials.

In one arrangement, only a portion of the width of the spacer is initially adhered to the membrane. Such partial adherence may facilitate removal of portions of the spacer from the portions of the membrane that will extend at least partially up the upright members. In such an arrangement, one or more release liners may allow for full adherence of the spacer to the membrane after desired portions of the spacer are removed.

According to another arrangement, a utility is provided for forming a sill pan in the opening of a building structure wherein separate membranes are utilized. Initially, a first waterproof membrane is applied to a first inside corner defined by the first end of a generally horizontal sill surface and a first upright member. A second waterproof membrane is applied to a second inside corner defined by the second end of the sill surface and a second upright member. Typically, the first and second membranes are sized such that the entire interface between the sill surface and the upright member is covered by the membrane. A third membrane is then disposed across at least a portion of the length of the sill surface. The third membrane extends between the first and second membranes. That is, first and second ends of the third membrane at least partially overlap the first and second membranes, respectively.

In one arrangement, the first and second ends of the third membrane are adhered to the first and second membranes, respectively. In one arrangement, the bottom surface of the third membrane is an adhesive surface. In such an arrangement, a release sheet may be removed from the bottom surface, and the membrane may be adhered to the first and second membrane as well as the sill surface. In one arrangement, the third membrane is cut to a length that corresponds with the length of the sill between the first and second upright members. To further enhance the waterproof qualities of the interface between the respective membranes, a sealant may be applied along the interface therebetween.

Applying the first and second membrane to the first and second inside corners entails applying a portion of each membrane to the sill surface and the corresponding upright member. In this regard, it may be desirable that the membranes be highly flexible and/or elastic. In such an arrangement, the membranes may be conformed to the portions of both sill plate and the upright member. In addition to adhering the first and second membranes to the sill surface and upright member, a portion of each of these membranes may be adhered to an outside surface of the structure. For instance, the membranes may extend across the width of the sill surface and over sheathing interconnected thereto such that the membranes may be adhered to an outside surface of the sheathing. To have such flexibility, it may be desirable that such membranes contain little or no reinforcement. In such an arrangement, membranes formed of a bituminous material or a butyl rubber compound may be utilized. However, it will be appreciated that other materials that provide flexibility, adherence and/or waterproofing properties may be utilized. In accordance with the present arrangement, a back dam may be formed to prevent water from flowing into the structure. As above, a back dam may be formed from a portion of the flexible membrane or may be formed from a spacer material interconnected to a top or bottom surface of the membrane. Again, a front edge of the membrane may extend over the front edge of the opening and be adhered to an outside surface of the structure. Further, a wicking material may be disposed over at least a portion of the top surface of the membrane to provide means for moving water on the sill surface to a location outside the building structure.

### BRIEF DESCRIPTION OF THE DRAWINGS

FIG. 1 is a perspective view of a first embodiment of a wicking membrane.

FIG. 2 is a cross sectional view of the wicking membrane of FIG. 1.

FIG. 3 is a cross sectional view of a second embodiment of a wicking membrane.

FIGS. 4A-4C illustrate a folding sequence to form the membrane of FIG. 1 into a sill pan.

FIG. 5 is a first perspective view of the wicking membrane forming a sill pan within a window opening.

FIG. 6 is a second perspective view of the wicking membrane forming a sill pan within a window opening.

FIG. 7 is a sectional view of the wicking membrane utilized with a window within a window opening.

FIG. 8 illustrates a first step for forming a second embodiment of a sill pan in a window opening.

FIG. 9 illustrates a second step for forming the second sill pan embodiment.

FIG. 10 illustrates a third step for forming the second sill pan embodiment.

FIG. 11 illustrates an alternate third step for forming the second sill pan embodiment.

FIG. 12 illustrates the second sill pan embodiment with an elevated back dam.

FIG. 13 illustrates another embodiment of a wicking membrane that incorporates a spacer material.

### DETAILED DESCRIPTION OF THE INVENTION

Reference will now be made to the accompanying drawings, which at least assist in illustrating the various pertinent features of the present invention. In this regard, the following description that utilizes a flexible membrane to form a sill pan in a window opening is presented for purposes of illustration and description. Furthermore, the description is not intended to limit the invention to the form disclosed herein. Consequently, variations and modifications commensurate with the following teachings, and skill and knowledge of the relevant art, are within the scope of the present invention. It will be appreciated that various aspects of the invention have utility for applications other than forming sill pans for windows and doors, for example, applications where it is desirable to remove moisture from a structure. The embodiments described herein are further intended to explain the best modes known of practicing the invention and to enable others skilled in the art to utilize the invention in such, or other embodiments and with various modifications required by the particular application(s) or use(s) of the present invention.

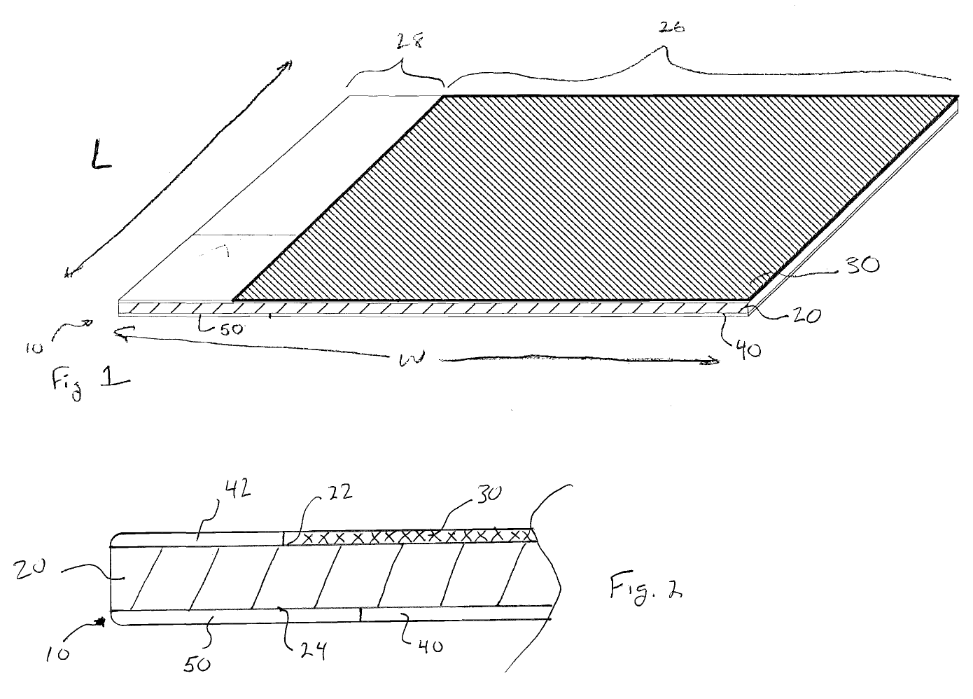

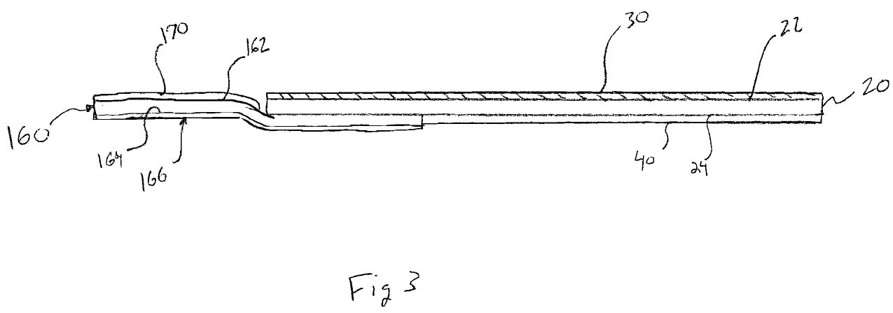

FIGS. 1 and 2 illustrate perspective and cross sectional views, respectively, of one embodiment of a wicking membrane 10 in accordance with certain aspects of the present invention. Generally, the membrane 10 is adapted for adhesive interconnection to a surface such that it may provide waterproofing qualities to the surface. Stated otherwise, the membrane provides a substantially impermeable barrier that may be applied to a surface to prevent moisture from contacting that surface. To further enhance the waterproofing qualities of the membrane, the membrane 10 includes a wicking material 30 that is attached to at least a portion of a first surface of the membrane 10. The wicking material 30 is adapted to move water from a first location on the membrane to a second location using capillary action. As may be appreciated, the wicking material 30 may be operative to move moisture out of the building envelope of a structure, as will be more fully discussed herein.

In the present embodiment, the membrane 10 is formed using an adhesive sheet member 20 having first and second opposing surfaces. For purposes of the discussion, the opposing surfaces are referred to as the top surface 22 and bottom surface 24. However, it will be appreciated that other naming conventions may be utilized. The construction of the adhesive sheet member of 20 may be varied. For instance, the adhesive sheet member 20 may be formed from any flexible sheet-like material that provides the desired level of impermeability. For instance, the sheet member 20 may be formed from a plastic sheet and have an adhesive applied to one or both of the top and bottom surfaces 22, 24. In an alternate arrangement, the adhesive sheet member 20 may be formed of a material that provides both waterproofing properties (e.g., impermeability) as well as adhesive properties. In one particular arrangement, the adhesive sheet 20 is formed from a bitumen-containing material. Such bitumen-containing materials may allow a bitumen-containing layer to provide adhesive qualities for the membrane 10 as well as provide waterproofing qualities for the membrane 10. Additionally, the sheet member 20 may itself be a multilayered structure. For instance, the sheet member 20 may be constructed having one or more reinforcing layers (e.g., mesh layers), base sheet layers (e.g., plastic sheet layers) and/or various adhesive layers (e.g., bitumen-containing layers).

Non-limiting examples of suitable materials for use in producing an adhesive sheet layer having waterproofing properties that include bitumen-containing materials such as various tar adhesives and rubberized asphalts, as well as natural and/or synthetic rubber (e.g., butyl-rubber) certain butyl-rubber compounds. For instance, the adhesive sheet member 20 may be at least partially constructed from a modified, rubberized asphalt material. The rubberized asphalt material may include a combination of petroleum, asphalt/road flux components (e.g., bituminous components) and/or miscellaneous additives.

The use of the bitumen-containing adhesive sheet member 20 allows for conveniently interconnecting the wicking material 30 to the top surface 22 of the sheet member 20. In this regard, the wicking material 30 also be formed in a sheet and may be applied to an exposed adhesive surface of the sheet member 20 in order to adhere the wicking member to that surface. Such application may be performed utilizing compressive rollers in a manner similar to that disclosed in U.S. Pat. No. 6,676,779 entitled “Air and moisture barrier laminate apparatus” the entire contents of which are incorporated herein by reference.

The wicking material 30 may be any material that is operative to effect the movement of moisture utilizing capillary action. In one embodiment, the wicking material is formed from an industrial felt. However, it will be appreciated that numerous other natural and synthetic materials may also be utilized.

In order to attach the membrane 10 to a surface, the bottom surface 24 of the adhesive sheet member 20 may be adapted for adhesive interconnection to a contacting surface. For instance, the membrane 10 may incorporate a release sheet 40 that is removably interconnected to the bottom surface 24 of the membrane 10. In this regard, the release sheet 40 may be removed from the bottom surface 24 such that adhesive associated with the bottom surface 24 may be contacted with a surface for which waterproofing is desired. Many different foils, films, papers or other sheet materials are suitable for use in constructing the release sheet 40. For example, the release sheet 40 may be formed from metals, plastics, or papers treated with silicon or other substances to provide a low level of adhesion to the underlying adhesive associated with the sheet member 20. In any case, it is desirable that the release sheet 40 be easily removable from the adhesive sheet 20.

In the embodiment illustrated in FIG. 1, the wicking material 30 covers a first portion 26 of less than the entire top surface 22 of the sheet member 20. A remaining second portion 28 of the top surface 24 is adapted to adhere the membrane 10 to a surface. As shown, the second portion 28 is formed as a strip along the length of the membrane 10. It should be noted that the membrane 10 may have any appropriate shape based on the requirements of a particular application. However, when utilized to create a window or door sill pan, as will be discussed herein, it may be desirable that the membrane 10 be formed as a elongated strip (e.g., a rectangular strip) having it length L that is typically larger than its width W. In such an arrangement, the first portion 26 and second portion 28 of the top surface 22 may be defined across the width of the membrane 10 such that each portion 26, 28 forms a strip along the length of the membrane 10.

To permit the second portion 28 of the top surface 22 to be adhesively attached to a surface, a second release sheet 42 may cover an adhesive surface associated with the second portion 28. Further, to allow the second portion 28 of the membrane 10 to be adhered to a surface that is transverse to the first portion of the membrane 10, the bottom surface 24 beneath the second section 28 may be formed from a non-adhesive backing member 50. For instance, the backing member 50 may be formed from a sheet of plastic that is permanently adhered to a portion of the bottom surface 24 of the sheet number 20. This may allow the top surface of the second portion 28 of the membrane 10 to be adhered to a surface in a first plane while the bottom surface of the first portion 26 of the membrane 10 is adhered to a surface in a second transverse plane.

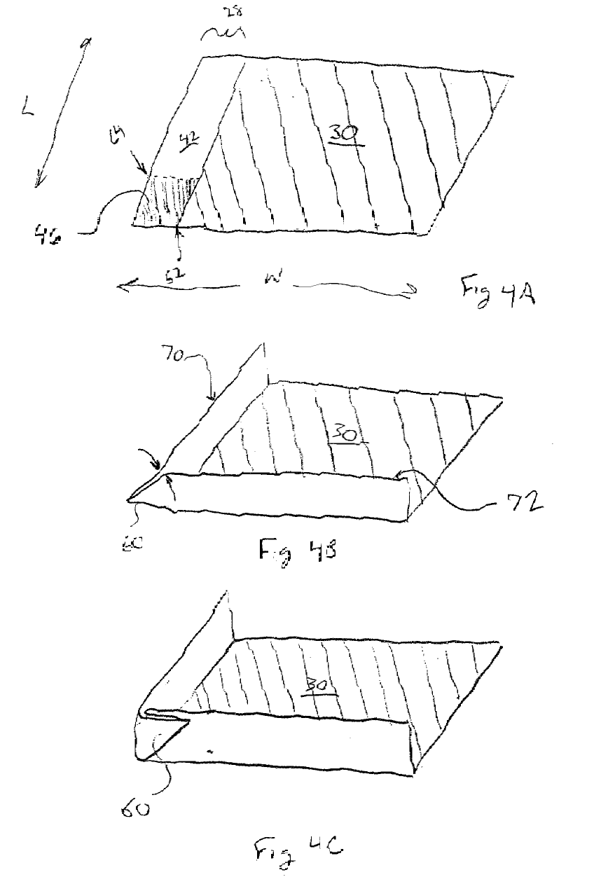

FIG. 3 illustrates another embodiment of a wicking membrane 10 where the membrane 10 is formed from first and second sheet members 20 and 160. The first sheet member 20 includes a top surface 22 to which a wicking material 30 is adhesively interconnected and a bottom surface 24 to which a release sheet 40 is releasably interconnected. As shown, the wicking material 30 extends across the entire top surface 22 of the first sheet member 20. In contrast, the release sheet 40 extends across only a portion of the bottom surface 24 of the first sheet member 20. As shown, the second sheet number 160 is adhesively interconnected to the first sheet member 20 on the portion of the bottom surface 24 that is not covered by the release sheet 40.

The second sheet number 160 includes an adhesive top surface 162 and a bottom surface 164. In the present embodiment, the bottom surface 164 is covered by a non-adhesive backing material 166 (e.g., a plastic sheet) to prevent the bottom surface 164 of the second sheet member 160 from adhering to a surface. A portion of the adhesive top surface 162 is adhered to the bottom surface 24 of the first sheet member 20. In this regard, the mating potions of the top surface 162 and bottom surface 24 may each be adhesive surfaces that are exposed and contacted together to interconnect the first and second sheet members 20, 160. The remaining portion of the adhesive top surface 162 of the second sheet member 160 is covered by a release sheet 170. This release sheet 170 may be selectively removed as will be discussed herein.

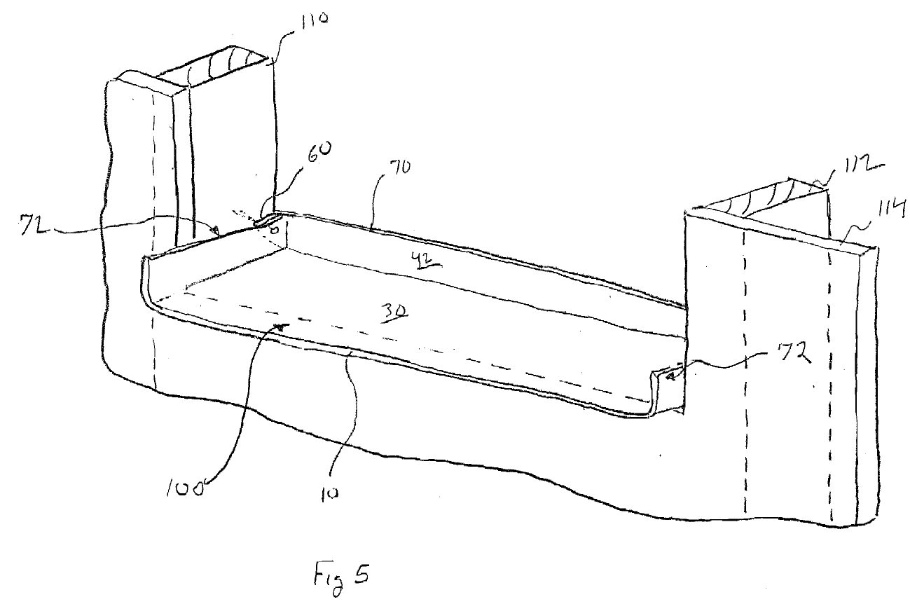

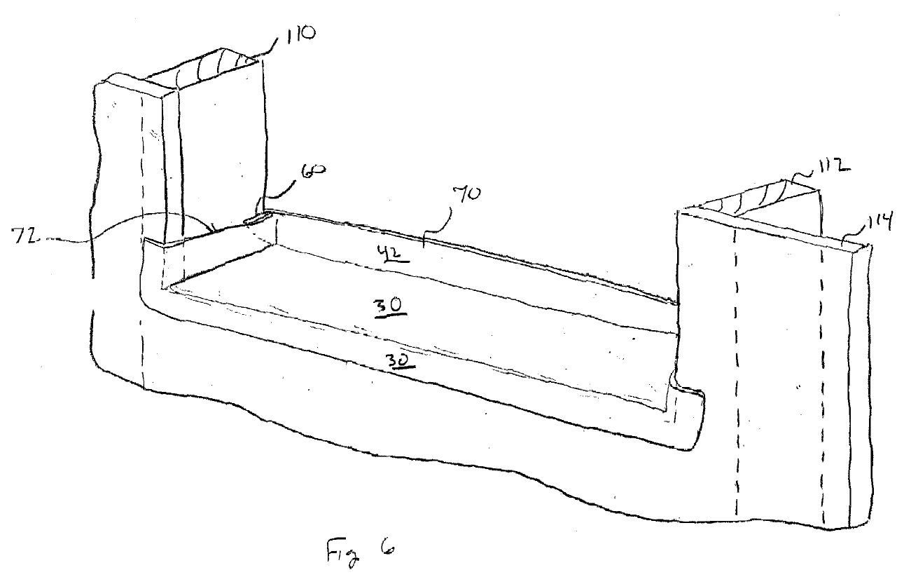

As noted above, one application for the wicking membrane 10 is to form a still pan for use with a door or window. FIGS. 4A-4C illustrate a method for forming the generally flat membrane 10 into a sill pan that may be positioned along a sill surface beneath a window or door. Such a sill pan may provide waterproofing for the sill surface as well as provide a means for moving moisture/water that has infiltrated behind a door or window out of a building envelope.

As shown in FIGS. 4A-4C, a sill pan may be formed by creating a dog-ear fold in a corner of the membrane 10. For purposes of discussion, the formation of a sill pan is discussed in relation to the membrane embodiment of FIG. 1 and 2, however, it will be appreciated that the sill pan may be formed from the membrane embodiment of FIG. 3 as well. As shown in FIG. 4A, a portion of the second release sheet 42 may be removed from the top surface 22 of the second portion 28 of the membrane 10 (i.e., the portion that is that is not covered by the wicking material 30) to expose an adhesive surface 46. Opposing points 62, 64 of the exposed adhesive surface may be moved into contact with one another to form an ear 60. As may be appreciated, the adhesive surface 46 may bond to itself when the opposing points 62, 64 are contacted. See FIG. 4B. In conjunction with forming the ear 60, the membrane 10 may be folded along its length and width to form an upstanding back dam 70 and an upstanding side wall 72, respectively. The ear 60 may then be folded against one of the back dam 70 and the side wall 72. See FIG. 4C. The same process may be repeated on an opposing end of the membrane 10 to form a sill ‘pan’ having an open front.

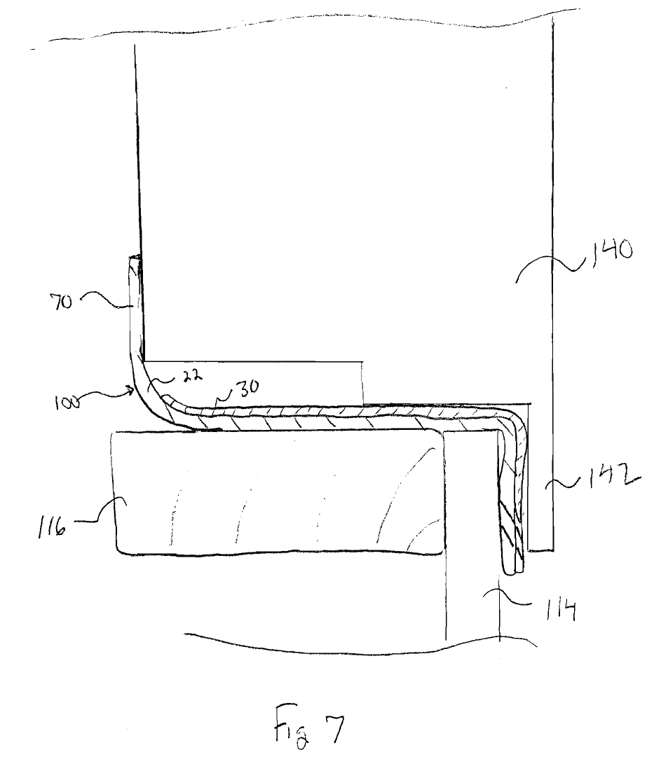

FIG. 5 illustrates such a sill pan 100 formed from the flexible membrane 10 in a window opening. The window opening includes a bottom cross member or windowsill (disposed beneath the sill pan, not shown) that extends between first and second upright studs 110, 112. As may be appreciated, such a window opening would also include a top cross member (not shown) that would extend between the first and second studs 110, 112. The resulting four-sided framework would define a window opening that may be sized to receive a window frame. As shown, sheathing material 114 is applied across to the outside surfaces of the studs 110, 112 around the window opening.

The sill pan 100 may be formed prior to being positioned within the window opening or the sill plan 100 may be formed in place. In the latter regard, a first end of the membrane 10 may be positioned adjacent to one of the studs, for example, stud 110 and a dog-ear corner 60 may be formed. As shown, this may permit forming a side wall 72 along the stud 110 and a back dam 70 that extends between studs 110, 112. An installer may tack or nail the folded ear 60 to the stud 110 to maintain the position of the sill pan 100 within window opening while the second end of the sill pan is formed adjacent to the other stud 112. As will be appreciated, the membrane 10 may come in any lengths and maybe cut to an appropriate length such that a second end of the membrane adjacent to stud 112 is of an appropriate length to form a second sidewall against the opposing stud 112. The back dam 70 and sidewalls 72 generally form a open fronted pan that is operative to receive any water that drains to the surface of the window sill and direct that water outside the building structure, as will be discussed herein.

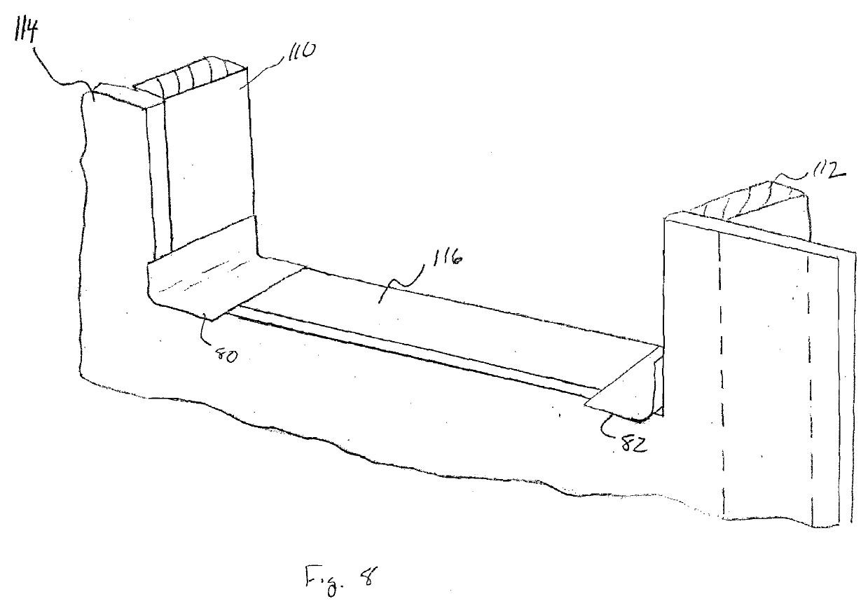

Once appropriately sized and formed, the bottom surface of the sill pan 100 may be adhered to the top of the windowsill. In this regard, the release sheet 40 may be removed from the bottom surface 26 of the membrane 10. See for example FIG. 1. An installer then adhesively secures the membrane 10 across entire length of the windowsill and partially up the studs 110, 112. Preferably, the width of the resulting still pan 100 is such that it extends beyond the front edge of the sheathing material 114. After the still pan 100 is adhered to the windowsill, the installer may fold a portion of the membrane 10 that extends beyond the sheathing material 114 downwardly and adhesively secure this portion to the front surface of the sheathing material 114 as seen in FIG. 6.

At this point, the sill pan 100 is fully installed and the wicking material 30 disposed on the top surface of the membrane 10 may extend from the back edge of the windowsill (i.e., adjacent to the back dam 70) across the width of the windowsill and downwardly onto the outside surface of the sheathing material 114. As will be appreciated, this may allow directing water from within the envelope of a building to an outside surface of the building. Specifically, as the wicking material 30 on the outside surface of the sheathing material 114 is disposed below the wicking material 30 on the generally horizontal window sill, capillary action will draw water across the sill. Further, the wicking material may be operative draw water over the sill even when the windowsill is not perfectly level. That is, the capillary action of the wicking material 30 may allow for wicking moisture up and over the front edge of a windowsill and to the outside surface of the sheathing material 114. In any case, the wicking material 30 directs water which penetrates a window outside of the a building envelope.

While the wicking material allows for removing water from the windowsill, the impermeability of the membrane 10 prevents water from contacting the generally wooden windowsill. This combination of the wicking and waterproofing properties may prevent structural damage of the windowsill and lessen the likelihood of mold forming within the walls of a completed structure.

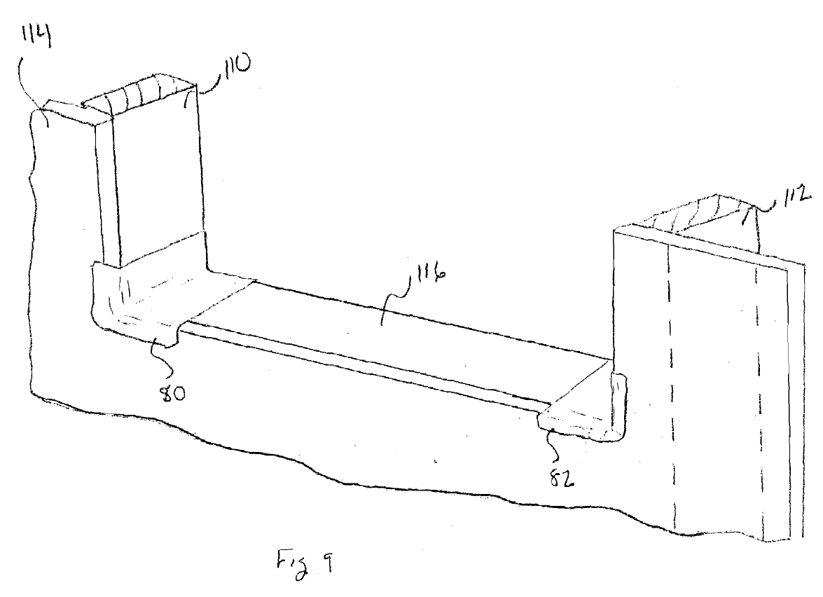

FIG. 7 illustrates a cross-sectional view of a window frame 140 being placed on to the sill pan 100. As shown, the window frame 140 is positioned in the window opening of the framework such that that a window frame flange 142 overlaps the outside surfaces of the sheathing material 114 around the perimeter of the window opening. A portion or all of the bottom of window frame 140 is positioned in contact with the top surface (i.e., wicking material 30) of the sill pan 100, which sets atop of the window sill 116. Generally the window frame 140 is held in place by inserting mechanical fasteners through the window flange 142 into the framework. Accordingly, caulk may be applied to the inside surface of the flange 142 to improve the sealing. Importantly, it should be noted that even if caulk is applied to the inside surface of the window flange, the wicking material 30 will still provide a path for moisture evacuation. Further, it may be desirable to apply a sealing tape to overlap the window flange 142 and the sheathing material 114 about the perimeter of the window frame 140.

The adhesive surface of the back dam 70 may then be utilized to adhere the back dam 70 to the window frame 140. As may be appreciated, this may provide support for the generally flexible back dam 70 between the upright studs 110, 112. To adhere the front surface of the back dam to the window frame,140, the window my be properly positioned and the release sheet 42 on the surface of the back dam 70 may be removed. An installer then adhesively secures the back dam across the length of the window frame 140. With this construction, moisture that leaks into the window through window flange 142 or the window itself can be wicked across the windowsill and out of the structure. Further, such moisture is prevented from penetrating the interior of a structure by the back dam 70.

When installing the membrane 10 as a window of doorsill pan, it should be appreciated that the elasticity of the membrane 10 generally allows an installer to pull and position the portion of the membrane 10 that extends beyond the sill onto the sheathing material 114 or other outside surface as desired. The membrane 10 may have a construction, which is air and moisture impermeable to define a long-lasting, effective sealing gasket, which is waterproof, and is mold and mildew resistant. As a result, subfloors and sills are prevented from rotting, swelling and warping, finish flooring is not destroyed and energy losses are abated with a noticeable savings in energy costs.

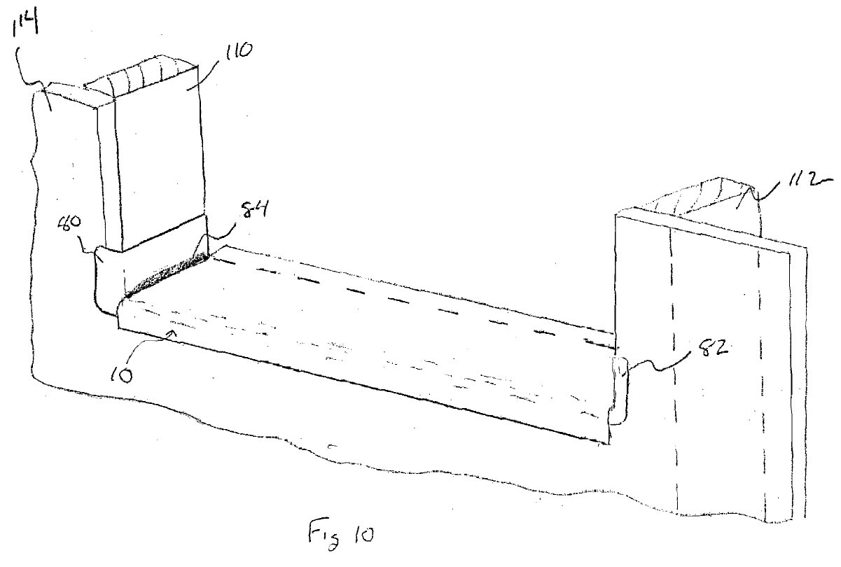

FIGS. 8-13 illustrate additional embodiments where a flexible membrane 10 is utilized to create a sill pan that may be utilized in a window opening or door opening. In contrast to the sill pan 100 described in relation to FIGS. 4-6, the embodiments of FIGS. 8-13 do not utilize a dog-eared corner to form a sill pan from a single membrane. Rather, as shown in FIG. 8, first and second flexible waterproof membranes 80, 82 are applied to the bottom inside corners of a window (or door) opening. As shown, a first flexible membrane 80 is adhered to the top surface of a windowsill 116 and a side surface of a corresponding stud 110. In this regard, the flexible membrane 80 seals the interface between the stud 110 and window sill 116. Likewise, a second flexible membrane 82 is adhered to the windowsill 116 and the opposing stud 112. Generally, the membranes 80, 82 extend from the rear edge of the windowsill 116, across the width of the windowsill 116 and sheathing 114 and extend a distance beyond the sheathing 114. As shown in FIG. 9, the portions of each membrane 80 that extend beyond the sheathing 114 may be pulled and adhered to the outside surface of the sheathing 114. In this regard, it may be desirable that the membranes 80, 82 be formed of a highly elastic material that permits their conformance to the inside corners of the opening as well as their molding to the outside surface of the sheathing 114. In one arrangement, the membranes 80, 82 are non-reinforced membranes. For instance, the membranes 80, 82 may be formed of a butyl rubber compound or a bituminous compound that has little or no internal reinforcement to enhance the permeability of the membranes 80, 82.

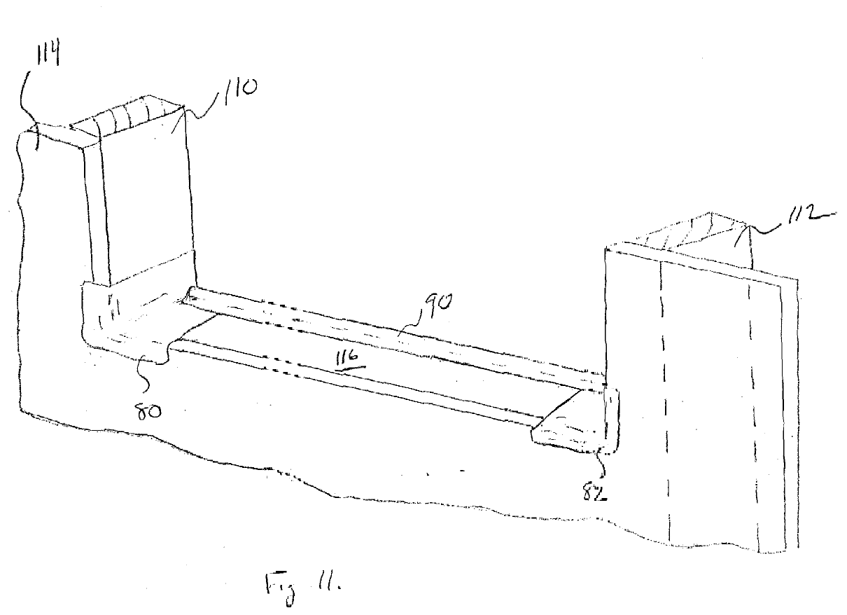

Once the membranes 80, 82 are affixed to the inside corners of the opening, a membrane 10 may be disposed across the surface of the windowsill 116 (See FIG. 10). For instance, the membrane 10 of FIG. 1 may be utilized. In this regard, the membrane 10 may be measured and cut to the length of the windowsill 116 as measured between the studs 110, 112. Once cut to length, a backing material may be removed from the bottom surface of the membrane 10 in order to adhere the membrane 10 to the windowsill. In this regard, the bottom surface of the membrane 10 will adhere to the top surface of the corner membranes 80, 82. Generally, such adherence between the opposing membranes will provide a substantially waterproof joint. However, it may be desirable to further improve the impermeability of the coupling between these membranes 10, 80 and 10, 82 by utilizing a sealant along the joint seam or interface therebetween. For instance, an appropriate caulking compound or selant may be utilized to seal the seam between membranes. For instance, as shown in FIG. 10, a bead of caulk 84 may be applied to the interface/seam between the flexible membrane 10 and the corner membrane 80.

As in the above-noted embodiment, a forward edge of the membrane 10 may be folded over the outside surface of the sheathing 114. At this time, a window may be placed on the top surface of the membrane 10. Accordingly, the rearward portion of the membrane 10 may be folded against and adhered to the rearward end of the window in order to create a back dam for the resulting sill pan.

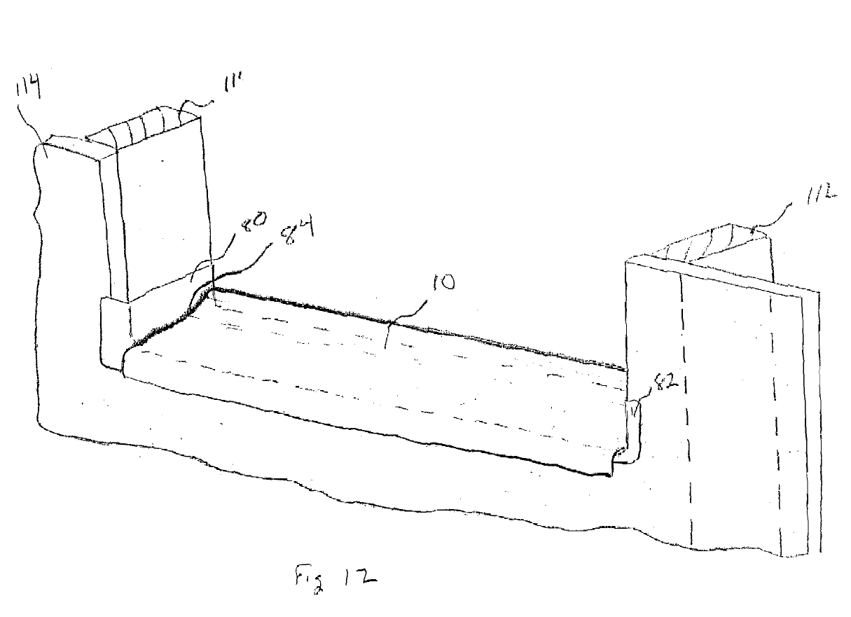

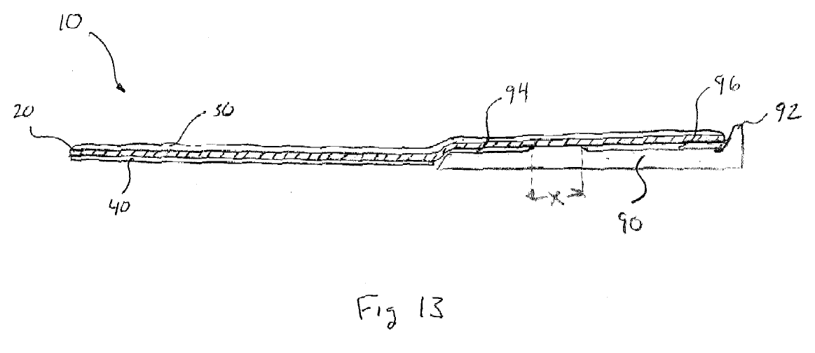

FIG. 11 illustrates another arrangement that may be utilized to generate a sill pan in accordance with the embodiments discussed herein. As shown, the embodiment of FIG. 11 again utilizes first and second membranes 80, 82 to seal the inside corners between the windowsill 116 and the studs 110, 112. In this arrangement, a back dam 90 is disposed on the surface of the windowsill 116 and extends between the upright studs 110, 112. The back dam 90 forms a structure that may, when covered by a flexible membrane, provide an elevated area along the rearward edge of the windowsill 116 that prevents water from infiltrating into the opening. Accordingly, when the windowsill 116 is covered by a membrane, a forward edge of the membrane extending over the outside surface of the sheathing 114 will typically be at a lower elevation than the portion of the membrane disposed over the back dam. Accordingly, the wicking material will thereby provide a flow path away from the rear of the sill 116 such that water may be directed out of the opening. As shown in FIG. 12, a membrane is disposed over back dam material (not shown) such that the rearward edge of the membrane 10 is elevated in relation to the forward edge of the membrane. Again, to enhance the coupling between the membrane 10 and the corner membranes 80, 82, a sealant 84 may be applied at the interfaces of those membranes 10, 80 and 10, 82. The back dam 90 (See FIG. 11) may be formed from any appropriate material. In one embodiment, the back dam is formed from a bead of caulk. In another embodiment, the back dam is a rigid member (e.g., a board) that is affixed across the windowsill. In another embodiment, a flexible material (e.g., closed cell foam) may be affixed across the windowsill.

To facilitate the use of a back dam material with the membrane 10, back dam or spacer material 90 may be incorporated onto the flexible membrane. As shown in FIG. 13, a portion of the width ‘x’ of the spacer material 90 is adhered to a bottom surface of a flexible sheet member 20. Such partial adherence of the spacer may facilitate removal of the spacer material 90 from the sheet member 20. For instance, in instances where the membrane 10 extends partially up upright members of a window opening, it may be desirable to remove the spacer material 90 form those portions of the membrane 10. Once the desired portions of the spacer material 90 are removed (not shown) one or more release sheets 94, 96 may be removed from interfacing portions of the sheet member 20. In this regard, the entire width of the remaining spacer material 90 may be adhered to the sheet member 20.

The flexible sheet member 20 has a top surface that is covered by a wicking material 30. Further, the remainder of the bottom surface of the sheet member 20 is covered by a release sheet 40 that allows for the membrane 10 to be adhered to a surface upon the selective removal of the release sheet 40. Of note, the sheet material 20 and/or wicking material 30 may not extend entirely over the surface of the spacer material 90. Further, the spacer material 90 may incorporate an upward projection 92 that extends above the wicking material 30. In this regard, the spacer material 90 may be aligned across a sill plate and as the wicking material does not extend over the upward extension 92 the spacer material 90 will prevent wicking of moisture into the opening.

While the invention has been described with reference to a preferred embodiment, those skilled in the art will appreciate that certain substitutions, alterations and omissions may be made without departing from the spirit thereof. Accordingly, the foregoing description is meant to be exemplary only and should not be deemed limitative on the scope of the invention set forth with the following claims.

1. A membrane for use in waterproofing a sill surface and directing water away from said sill surface, comprising:
a flexible waterproof sheet member having a top surface and a bottom surface;
a wicking material attached to a first portion of the top surface;
an adhesive associated with a second portion of said top surface; and
a first release sheet releaseably attached to at least said second portion of said top surface.

2. The membrane of claim 1, wherein said adhesive and said wicking material collectively cover an entirety of said top surface.

3. The membrane of claim 1, wherein said sheet member comprises an elongated sheet member having length dimension greater than a width dimension.

4. The membrane of claim 3, wherein said wicking material is disposed over a first portion of the width of said elongated sheet member and said adhesive is associated with a second portion of the width of said elongated sheet member.

5. The membrane of claim 1, wherein said adhesive comprises an adhesive material integrally formed with said sheet member.

6. The membrane of claim 5, wherein said adhesive material comprises at least one of:
a bitumen containing material;
a rubber containing material

7. The membrane of claim 1, wherein said adhesive comprises an adhesive applied to said second portion of said top surface of said sheet member.

8. The membrane of claim 1, further comprising:
a second release sheet releaseably attached to at least a first portion of said bottom surface, wherein said release sheet releasable covers an adhesive associated with said bottom surface.

9. The membrane of claim 8, wherein said adhesive associated with said bottom surface comprises an adhesive material integrally formed with said sheet member.

10. The membrane of claim 8, further comprising:
a non-adhesive surface associated with at least a second portion of said bottom surface.

11. A method for forming a sill pan on a sill surface of an opening in building structure, comprising:
disposing a flexible membrane across the length of a generally horizontal sill surface disposed between first and second upright members, wherein a first end of said flexible membrane extends at least partially up said first upright member and a second end of said flexible membrane extends at least partially up said second upright member;
folding a rearward edge of said membrane disposed between said first and second uprights, transverse to said generally horizontal sill surface, wherein a resulting transverse portion of said membrane forms a backdam between said first and second uprights.

12. The method of claim 11, further comprising:
disposing a window over said membrane disposed across said sill surface; and
attaching said transverse portion of said membrane to said window.

13. The method of claim 12, wherein attaching comprises:
removing a release sheet from at least a portion of said transverse portion of said membrane to expose an adhesive surface; and
contacting said adhesive surface to said window.

14. The method of claim 11, further comprising:
removing a release sheet from at least a portion of a bottom surface of said flexible membrane to expose a bottom adhesive surface; and
contacting at least a portion of said adhesive surface to said sill surface.

15. The method of claim 14, further comprising:
contacting a first end portion of said bottom adhesive surface to said first upright member; and
contacting a second end portion of said bottom adhesive surface to said second upright member.

16. A method for forming a sill pan on a sill surface of an opening in building structure, comprising:
disposing a flexible membrane across the length of a generally horizontal sill surface disposed between first and second upright members, wherein a first end portion of said flexible membrane extends at least partially up said first upright member and a second end portion of said flexible membrane extends at least partially up said second upright member;
removing a spacer material disposed on a bottom surface of said flexible membrane from said first and second end portions;
removing a release sheet from at least a portion of a bottom surface of said flexible membrane to expose a bottom adhesive surface; and
contacting at least a portion of said adhesive surface to said sill surface.

17. The method of claim 16, further comprising:
contacting a bottom adhesive surface associated with said first end portion to said first upright member; and
contacting a bottom adhesive surface associated with said second end portion to said second upright member.

18. The method of claim 16, wherein disposing comprises aligning a back edge of said flexible membrane along a reference line disposed a predetermined distance from a front edge of said sill surface and extending across the length of said sill surface.

19. The method of claim 16, wherein an edge of said spacer material is disposed proximate to said reference line across the length of said sill surface.

20. A method for forming a sill pan for an opening in building structure, comprising:
first applying a first waterproof membrane to a first inside corner defined by a first end of a generally horizontal sill surface and a first upright member;
second applying a second waterproof membrane to a second inside corner defined by a second end of said sill surface and a second upright member;
disposing a third waterproof membrane across at least a portion of the length of said sill surface, wherein first and second ends of said third membrane at least partially overlap said first and second membranes, respectively.

21. The method of claim 20, further comprising:
adhering said first and second ends of said third membrane to said first and second membranes, respectively.

22. The method of claim 21, further comprising removing a release sheet from at least a portion of a bottom surface of said third membrane to expose a bottom adhesive surface; and
contacting at least a portion of said adhesive surface to said sill surface.

23. The method of claim 21, further comprising:
applying a sealant to an interface between said first membrane and said first end of said third membrane; and
applying a sealant to an interface between said second membrane and said second end of said third membrane.

24. The method of claim 21, wherein said first and second applying steps each comprise adhering one of said first and second membranes to a respective one of said inside corners.

25. The method of claim 24, wherein a first portion of each of said membrane is adhered to said sill surface and a second portion of each said membrane is adhered to a respective one of said upright members.

26. The method of claim 25, wherein said first and second applying steps each comprise adhering a front portion of each of said first and second membranes to a face surface that is transverse to both said sill surface and said upright members.

27. The method of claim 20, further comprising:
aligning a back edge of said third membrane along a reference line disposed a predetermined distance from a front edge of said sill surface and extending across the length of said sill surface.

28. The method of claim 27, wherein a spacer material attached to said third membrane is disposed proximate to said reference line across the length of said sill surface.
